(19) United States
(12) Patent Application Publication
(10) Pub. No.: US 2010/0312411 A1
(43) Pub. Date: Dec. 9, 2010

(54) AC CONSUMPTION CONTROLLER, METHOD OF MANAGING AC POWER CONSUMPTION AND A BATTERY PLANT EMPLOYING THE SAME

(75) Inventor: John C. Brooke, Dallas, TX (US)

Correspondence Address: HITT GAINES P.C., P.O. BOX 832570, RICHARDSON, TX, 75083, US

(73) Assignee: Lineage Power Corporation, Mesquite, TX (US)

(21) Appl. No.: 12/479,642

(22) Filed: Jun. 5, 2009

(51) Int. Cl. G06F 1/30; H02J 9/06

(52) U.S. Cl. 700/292; 307/66

(57) ABSTRACT

An AC consumption controller, a method of managing AC power received at a battery plant in response to AC supply conditions and a battery plant are disclosed herein. In one embodiment, the AC consumption controller include: (1) an AC supply monitor configured to recognize an AC supply event associated with a battery plant having at least one rectifier, a battery supply and a DC bus having a DC load current and configured to supply a DC voltage, the DC bus coupled to the rectifier and the battery supply and (2) an AC supply adjuster configured to maintain an AC power level for the AC supply event by regulating the DC voltage throughout the AC supply event to share sources of the DC load current between an output battery current of the battery supply and an output rectifier current of the rectifier.

### TECHNICAL FIELD OF THE DISCLOSURE

The present disclosure is directed, in general, to power systems and, more specifically, to battery plants and controlling the AC power received by the battery plants.

### BACKGROUND OF THE DISCLOSURE

Backup power equipment is typically used in systems requiring high reliability, such as electrical power systems and telecommunication systems. In telecommunication and data switching systems, tens of thousands of calls and data connections are routed per second. The failure of such a system, due to either an equipment breakdown or a loss of power, is generally unacceptable since it would result in a loss of millions of voice and data communications along with its corresponding revenue. As such, the traditionally high reliability of telecommunication systems, that users have come to expect, is partially based on the use of redundant equipment including power supplies.

Primary power for such highly reliable systems is commercially available AC voltage that is normally supplied through power grids. Should the AC voltage become unavailable due to an AC power outage or the failure of one or more of its associated components, the backup power equipment supplies the needed voltages and currents to maintain operation of the system. This backup power capability can be provided by a battery plant, which generally includes a number of backup batteries as well as corresponding rectifiers, inverters and associated power distribution equipment.

The backup batteries provide power to the load in the event an AC power outage occurs. During normal operation, i.e., a normal operating mode, the backup batteries are usually maintained in a substantially fully-charged state to provide as long duration for backup power as possible. Multiple rectifiers may be connected to the battery plant's output bus to provide the needed load current for systems and maintain the battery charge during these normal operating periods.

### SUMMARY OF THE DISCLOSURE

In one aspect the disclosure provides an AC consumption controller. In one embodiment, the AC consumption controller include: (1) an AC supply monitor configured to recognize an AC supply event associated with a battery plant having at least one rectifier, a battery supply and a DC bus having a DC load current and configured to supply a DC voltage, the DC bus coupled to the rectifier and the battery supply and (2) an AC supply adjuster configured to maintain an AC power level for the AC supply event by regulating the DC voltage throughout the AC supply event to share sources of the DC load current between an output battery current of the battery supply and an output rectifier current of the rectifier.

In another aspect, a method of managing AC power received at a battery plant in response to AC supply conditions is provided. In one embodiment, the method includes: (1) recognizing an AC supply event associated with a battery plant having at least one rectifier, a battery supply and a DC bus having a DC load current and configured to supply a DC voltage, the DC bus coupled to the rectifier and the battery supply and (2) regulating, throughout the AC supply event, the DC voltage to share sources of the DC load current between an output battery current of the battery supply and an output rectifier current of the rectifier to maintain an AC power level for the AC supply event.

In yet another aspect, a battery plant is disclosed. In one embodiment, the battery plant includes: (1) a battery string coupled to a DC output bus having a DC load current and configured to supply a DC voltage, (2) a rectifier system coupled to the DC output bus and (3) an AC consumption controller coupled to the battery string and the rectifier system, the AC consumption controller, having: (3A) an AC supply monitor configured to recognize an AC supply event associated with the battery plant and (3B) an AC supply adjuster configured to maintain an AC power level for the AC supply event by regulating the DC voltage throughout the AC supply event to share sources of the DC load current between an output battery current of the battery string and an output rectifier current of the rectifier system.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure. Those skilled in the art should also realize that such equivalent constructions do not depart from the spirit and scope of the disclosure.

### BRIEF DESCRIPTION OF THE DRAWINGS

For a more complete understanding of the present disclosure, reference is now made to the following descriptions taken in conjunction with the accompanying drawings, in which:

FIG. 1 illustrates a block diagram of an embodiment of a battery plant constructed in accordance with the principles of the present disclosure; and

FIG. 2 illustrates a flow diagram of an embodiment of a method of managing DC load in a battery plant in response to AC supply conditions carried out in accordance with the principles of the present disclosure.

### DETAILED DESCRIPTION

In addition to using the backup batteries to provide power when an AC power outage occurs, it would also be beneficial to use the backup batteries during an AC supply event when AC power can be or needs to be reduced in response to supply conditions. An AC supply event can occur, for example, when voltage drops below a predetermined threshold on the AC power grid or at a certain time of day when load on the AC power grid is typically high. The AC power may be reduced by managing customer consumption of electricity, such as, reducing their consumption at critical times. A “demand response” is an example of an AC supply event in power grids that provides a mechanism to manage customer electricity consumption in response to supply conditions. Demand response may be employed, for example, to balance supply and demand at system peak or to avoid high on-peak electricity purchases. A demand response mechanism may respond by switching to a different source of power, such as a battery plant. Typical methods of demand response in battery plants do not provide active control of the level of AC consumption during an AC supply event nor offer protection to the performance of the battery plant.

The present disclosure provides an apparatus and method that allow operators of battery plants to temporarily reduce AC power consumption. As disclosed herein, the apparatus and method may specify the level of AC power consumed by a battery plant during an AC supply event by starting a controlled discharge of the batteries. An AC consumption controller may be programmed to perform an algorithm that will regulate the DC plant voltage of the battery plant in such a way as to split the DC load current between the batteries and the rectifiers of the battery plant. The AC consumption controller will continually adjust the DC plant voltage so the AC power consumption meets a specified target, the AC power level for the specific AC supply event. Conventional battery plants typically reduce the AC consumption of a battery plant by reducing the plant voltage to a predetermined level. In contrast to this open-loop approach, the disclosure provides actively controlling the AC power reduction of a battery plant and employing safeguards with respect to the depth or rate of the battery discharge.

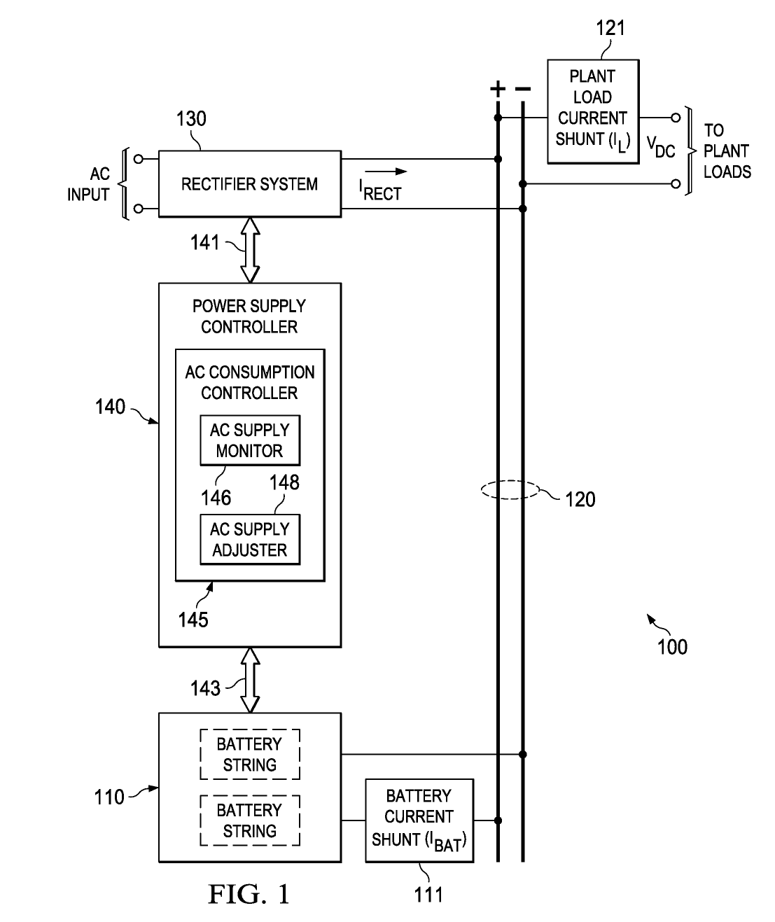

Referring initially to FIG. 1, illustrated is a block diagram of an embodiment of a battery plant 100 constructed in accordance with the principles of the present disclosure. The battery plant 100 includes a collection of battery strings 110, associated with a battery current I_{BAT} and coupled to a DC output bus 120 having positive and negative conductors that provides a plant load current I_{L} to battery plant loads. The battery plant 100 also includes a rectifier system 130 having at least one rectifier. The rectifier system 130 converts input AC power into a DC output voltage for the output bus 120 and also provides an output rectifier current I_{RECT} to the output bus 120. The rectifier system 130 may include remotely controlled rectifiers, non-remotely controlled rectifiers or a combination thereof.

The battery plant 100 further includes a power supply controller 140 that is coupled to the rectifier system 130 employing a first bus 141 and to the battery string 120 employing a second bus 143. The first bus 141 is employed to receive status and output rectifier current information from the rectifier system 130. The second bus 143 is employed to receive status and output battery current information from the battery string 130. The first bus 141 and the second bus 143 may be serial buses. Of course, one skilled in the pertinent art will recognize that communication schemes other than serial buses may be employed to receive the status and output current information, such as parallel or wireless connections.

The power supply controller 140 is also coupled to a plant load current shunt 121 that provides a representation of the plant load current I_{L} and to a battery current shunt 111 that similarly provides a representation of the battery current I_{BAT}. The connections between the power supply controller 140 and the shunts 111, 121, (not illustrated) may be wireless or wired connections. The power supply controller 140 includes an AC consumption controller 145 having an AC supply monitor 146 and an AC supply adjuster 148. The AC consumption controller 145 may be embodied as a series of operating instructions in a memory of the power supply controller 140 that perform the described functions when initiated by a processor. In some embodiments, the AC consumption controller 145 may be an individual component having the necessary hardware, such as a memory and a processor, and software to perform the described functions.

The AC supply monitor 146 is configured to recognize an AC supply event associated with the battery plant 100. The AC supply monitor 146 may be configured to recognize an AC supply event as conventional electrical customers may recognize a demand response. In some embodiments, a timer may be used to indicate typical low peak or high peak loads on the AC system. In other embodiments, the AC supply monitor 146 may be configured to communicate with an electrical substation or power plant of the AC grid to monitor and recognize an AC supply event. Additionally, the AC supply monitor 146 may monitor the frequency of the AC grid to determine a frequency threshold that is defined as an AC supply event. Different frequency thresholds may be defined with each having an associated reduction of AC consumption. In some embodiments, the associated AC power level for the different frequency thresholds may vary.

The AC supply adjuster 148 is configured to maintain an AC power level for the AC supply event by regulating the DC voltage during the AC supply event to share sources of the DC load current between the output battery current I_{BAT} and the output rectifier current I_{RECT}. To obtain the AC power level, the AC supply adjuster 148 may initiate a discharge of the battery string 110. By regulating the DC voltage during the AC supply event, the AC supply adjuster 148 actively controls the AC consumption level of the battery plant 100. The AC supply adjuster 148 is configured to adjust the DC voltage so the AC power consumption of the battery plant 100 meets the AC power level for the AC supply event. Different AC power levels may correspond to various AC supply events. The AC power levels may be predetermined values that are assigned to the AC supply events based on the events.

By increasing the DC voltage, more current for the DC plant load will be drawn from the rectifier system 130 and less current will be drawn from the battery string 110. As such, the AC power consumption of the battery plant 100 will increase. By decreasing the DC voltage, more current for the DC plant load will be drawn from the battery string 110 and less drawn from the rectifier system 130. As such, the AC power consumption for the battery plant 100 will decrease. In one embodiment, the AC supply adjuster 148 is configured to regulate the DC voltage by simultaneously monitoring the output battery current I_{BAT} and the plant load current I_{L} via the current shunts 111, 121, respectively.

The AC supply adjuster 148 can manage the AC power consumption of the battery plant while also safeguarding the battery string 110 from damage. For example, the AC supply adjuster 148 is also configured to regulate the DC voltage based on a discharge rate of the battery string 110. Additionally, the AC supply adjuster 148 may regulate the DC voltage based on a discharge depth of the battery string 110. In some embodiments, the AC supply adjuster 148 may regulate the DC voltage by returning the DC voltage to a normal operating level based on one of several conditions. The conditions may include when the duration of the AC supply event exceeds a certain value (e.g., a certain number of minutes or hours), when the DC voltage drops below a certain value (e.g., a predetermined voltage value) or when the energy removed from the battery string 110 exceeds a certain value (e.g., an amount of coulombs removed from the battery string 110). The duration, voltage value and energy removed may be based on the size and type of batteries in the battery string 110 and the reserve time they are expected to provide. Manufacturer's rating or guidelines for the batteries can be used. A customer may also provide input for determining the discharge rate and/or depth of the battery string 110. For example, a customer may want to insure a different battery reserve capacity, e.g., a higher reserve capacity, than recommended by a manufacturer. Accordingly, the AC supply adjuster 148 may be configured to receive and consider input, such as customer input, when regulating the DC voltage. The AC supply monitor 146 may also be configured to determine AC supply outages, such as “rolling outages” or “rolling blackouts” when a utility turns off power on selected portions of an AC grid to reduce load, and inform the AC supply adjuster 148. The AC supply adjuster 148 may consider such an outage and determine if battery capacity of the battery string 110 is sufficient to supply the plant load during the outage. As such, the AC supply adjuster 148 can manage the AC power consumption of the battery plant while also safeguarding the battery string 110 from damage.

After termination of the AC supply event, the AC supply adjuster 148 returns the DC voltage to a normal operating level. The AC supply adjuster 148 may perform this task by setting the power supply controller 140 in the normal operating mode. Under normal conditions, I_{RECT} equals I_{L} and the current used to charge the battery string 110, I_{CHARGE}. During an AC supply event, I_{RECT} equals I_{L} minus I_{BAT}.

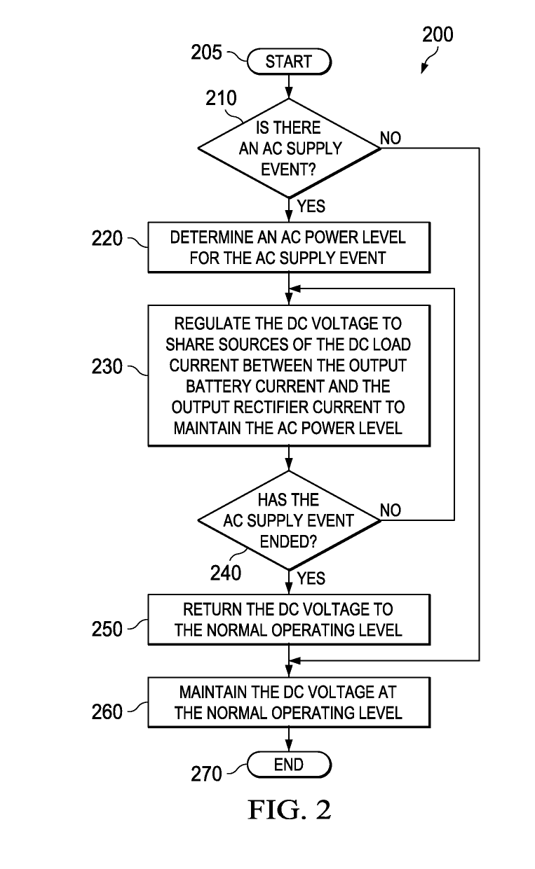

Turning now to FIG. 2, illustrated is a flow diagram of an embodiment of a method 200 of managing DC load in a battery plant in response to AC supply conditions carried out in accordance with the principles of the present disclosure. The method 200 is for use with a battery plant having at least one rectifier, a battery supply and a DC bus having a DC load current and configured to supply a DC voltage. Both the rectifier and the battery supply are coupled to the DC bus. At least part of the method may be performed by an AC consumption controller, such as the AC consumption controller 145 of FIG. 1. The method 200 starts in a step 205.

In a first decisional step 210 a determination is made if there is an AC supply event. If there is an existing AC supply event associated with the battery plant, an AC power level for the AC supply event is determined in a step 220. The DC voltage is then regulated in a step 230 to share sources of the DC load current between an output battery current and an output rectifier current to maintain the AC power level.

In a second decisional step 240 a determination is made if the AC supply event has terminated. If the AC supply event has not terminated, the method 200 continues to maintain the AC power level by regulating the DC voltage in step 230. If the AC supply event has ended, the DC voltage is returned to the normal operating level in a step 250. Thereafter, the DC voltage is maintained at the normal operating level in a step 260, e.g., return to the normal operating mode. The method 200 then ends in a step 270. Returning now to the first decisional step 210, if there is not an AC supply event, then the method 200 continues to step 260.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Although the present disclosure has been described in detail, those skilled in the art should understand that they can make various changes, substitutions and alterations herein without departing from the spirit and scope of the disclosure in its broadest form.

What is claimed is:

1. An AC consumption controller, comprising:
an AC supply monitor configured to recognize an AC supply event associated with a battery plant having at least one rectifier, a battery supply and a DC bus having a DC load current and configured to supply a DC voltage, said DC bus coupled to said rectifier and said battery supply; and
an AC supply adjuster configured to maintain an AC power level for said AC supply event by regulating said DC voltage throughout said AC supply event to share sources of said DC load current between an output battery current of said battery supply and an output rectifier current of said rectifier.

2. The AC consumption controller as recited in claim 1 wherein a plurality of AC supply events is associated with said battery plant and a different AC power level corresponds to at least two of said AC supply events.

3. The AC consumption controller as recited in claim 1 wherein said AC supply adjuster is further configured to initiate a discharge of said battery supply to obtain said AC power level.

4. The AC consumption controller as recited in claim 1 wherein said AC supply adjuster is further configured to return said DC voltage to a normal operating level after termination of said AC supply event.

5. The AC consumption controller as recited in claim 1 wherein said AC supply adjuster is further configured to regulate said DC voltage based on a discharge rate of said battery supply.

6. The AC consumption controller as recited in claim 1 wherein said AC supply adjuster is further configured to regulate said DC voltage based on a discharge depth of said battery supply.

7. The AC consumption controller as recited in claim 1 wherein said AC supply event is a demand response event.

8. A method of managing AC power received at a battery plant in response to AC supply conditions, comprising:
recognizing an AC supply event associated with a battery plant having at least one rectifier, a battery supply and a DC bus having a DC load current and configured to supply a DC voltage, said DC bus coupled to said rectifier and said battery supply; and
regulating, throughout said AC supply event, said DC voltage to share sources of said DC load current between an output battery current of said battery supply and an output rectifier current of said rectifier to maintain an AC power level for said AC supply event.

9. The method as recited in claim 8 wherein a plurality of AC supply events are associated with said battery plant and a different AC power level corresponds to at least two of said AC supply events.

10. The method as recited in claim 8 further comprising initiating a discharge of said battery supply to said DC bus to obtain said AC power level.

11. The method as recited in claim 8 further comprising returning said DC voltage to a normal operating level after termination of said AC supply event.

12. The method as recited in claim 8 wherein said regulating is based on a discharge rate of said battery supply.

13. The method as recited in claim 12 wherein said regulating is further based on a discharge depth of said battery supply.

14. The method as recited in claim 8 wherein said AC supply event is a demand response event.

15. A battery plant, comprising:
a battery string coupled to a DC output bus having a DC load current and configured to supply a DC voltage;
a rectifier system coupled to said DC output bus; and
an AC consumption controller coupled to said battery string and said rectifier system and including:
an AC supply monitor configured to recognize an AC supply event associated with said battery plant; and
an AC supply adjuster configured to maintain an AC power level for said AC supply event by regulating said DC voltage throughout said AC supply event to share sources of said DC load current between an output battery current of said battery string and an output rectifier current of said rectifier system.

16. The battery plant as recited in claim 15 wherein a plurality of AC supply events are associated with said battery plant and a different AC power level corresponds to at least two of said AC supply events.

17. The battery plant as recited in claim 15 wherein said AC supply adjuster is further configured to initiate a discharge of said battery supply to obtain said AC power level.

18. The battery plant as recited in claim 15 wherein said AC supply adjuster is further configured to return said DC voltage to a normal operating level after termination of said AC supply event.

19. The battery plant as recited in claim 15 wherein said AC supply adjuster is further configured to regulate said DC voltage based on a discharge rate of said battery string.

20. The battery plant as recited in claim 15 wherein said AC supply adjuster is further configured to regulate said DC voltage based on a discharge depth of said battery string.
